(19) United States
(12) Patent Application Publication
(10) Pub. No.: US 2015/0241040 A1
(43) Pub. Date: Aug. 27, 2015

(54) Retrofit Bracket Assemblies and Methods

(71) Applicant: Charles E. Rigby, (US)

(72) Inventor: Charles E. Rigby, Gainesville, GA (US)

(21) Appl. No.: 14/633,569

(22) Filed: Feb. 27, 2015

Related U.S. Application Data
(60) Provisional application No. 61/945,576, filed on Feb. 27, 2014.

(51) Int. Cl. F21V 21/14; F16B 9/02; F21V 5/04; F16M 13/02

(52) U.S. Cl. CPC F21V 21/14; F16M 13/02; F16B 9/023; F21V 5/04

(57) ABSTRACT

Bracket assemblies and methods of securing a new fixture to an existing base are presented. A bracket assembly, in one embodiment, includes an elongate plate having a base area and one or more struts formed by bending, a fastener to attach the base area to the new fixture, and a clamp to secure the struts to the existing base. Each strut may include one or more transverse apertures positioned at one or more intermediate locations along its length, wherein the apertures are sized and shaped to facilitate breaking and thereby selectively adjust the length of each strut. Selectively adjusting the length of the bracket assembly facilitates the placement of the new fixture at the desired position inside an existing housing.

### CROSS-REFERENCE TO RELATED APPLICATIONS

This application claims the benefit of U.S. Provisional Application 61/945,576, entitled “Retrofit Bracket Assemblies and Methods,” filed Feb. 27, 2014, which is incorporated herein by reference in its entirety.

### BACKGROUND

Certain disclosed embodiments relate to the field of brackets and, more particularly, to a bracket assembly for securing a new fixture to the base of an existing fixture.

Many existing light bulbs are supported by a generally cylindrical base or socket. For example, a typical incandescent light bulb having an Edison-type threaded metal base is typically received and supported by a matching Edison-type screw socket in a generally cylindrical base. Edison-type screw sockets may be found in a variety of incandescent lamps, from household fixtures to larger commercial fixtures such as the E39 “Mogul” screw mounts that are used for street lights and other high-wattage light fixtures.

Retrofitting existing light fixtures typically involves removing parts of the old lamp or bulb and installing new components. Many newer lamps, such as LED lamp assemblies, do not use a screw-type mount for mounting the lamp to the fixture. Also, LED lamps typically require a separate driver and power supply. When an existing fixture uses an Edison-type screw socket, but the new lamp assembly does not, the installer must remove the old socket or work around it. This work increases the time and costs associated with many retrofit projects. Moreover, the existing screw-mount base may be serving as the primary structural support for the entire fixture assembly, making the option of removing it more complicated or totally impractical.

Accordingly, there is a need in the art for an improved bracket assembly for supporting a new lamp assembly when the old lamp or bulb is supported by a generally cylindrical base.

### SUMMARY

A bracket assembly for securing an object at a selectively adjustable distance from a substantially cylindrical base is described. According to particular embodiments, the bracket assembly includes an elongate plate, a fastener, and a clamp. The elongate plate may be formed from a single piece of rigid material and shaped when bent to define, in its load-bearing configuration, a bracket having a base area, a first strut, and a second strut.

The first strut is contiguous with the base area along a first bendable region, and the first strut defines a first aperture positioned at one or more intermediate locations between the base area and a first distal end of the first strut, wherein the first aperture is sized and shaped to facilitate the breaking of the first strut near the first aperture to thereby selectively adjust the length of the first strut.

The second strut is contiguous with the base area along a second bendable region, and the second strut defines a second aperture positioned at one or more intermediate locations between the base area and a second distal end of the second strut, wherein the second aperture is sized and shaped to facilitate the breaking of the second strut near the second aperture to thereby selectively adjust the length of the second strut.

Each of the first and second struts has a concavely curved inner surface shaped to substantially correspond to an outer surface of a substantially cylindrical base. The base area defines a hole for receiving a fastener.

The bracket assembly also includes a fastener for securing the base area to an object, and a clamp sized and shaped to at least partially surround and draw together the first and second struts about the substantially cylindrical base.

A method for securing a new fixture at a selectively adjustable distance from the base of an existing fixture is also described. The method, according to particular embodiments includes the steps of: (1) removing an existing fixture from its substantially cylindrical base; (2) selecting an elongate plate, formed from a single piece of rigid material, wherein the elongate plate includes a base area defining a hole for receiving a fastener; (3) securing the base area to a new fixture using the fastener; (4) bending the elongate plate along a first bendable region to form a first strut, the first strut defining a first aperture positioned at one or more intermediate locations between the base area and a first distal end of the first strut, wherein the first aperture is sized and shaped to facilitate breakage of the first strut near the first aperture; (5) bending the elongate plate along a second bendable region to form a second strut, the second strut defining a second aperture positioned at one or more intermediate locations between the base area and a second distal end of the second strut, wherein the second aperture is sized and shaped to facilitate breakage of the second strut near the second aperture; (6) selecting a desired distance between the new fixture and the substantially cylindrical base, and selectively adjusting the length of the first and second struts by breaking the first and second struts near one of the intermediate locations in order to achieve the desired distance; and (7) positioning and securing a clamp at least partially around the first strut, the second strut, and the substantially cylindrical base.

Other apparatuses, methods, systems, features, and advantages of the disclosed embodiments will be apparent to one of ordinary skill in the art upon examination of the following figures and detailed description. All such additional apparatuses, methods, systems, features, and advantages are intended to be included within this description and to be included within the scope of the accompanying claims.

### BRIEF DESCRIPTION OF THE DRAWING

Features of the various embodiments disclosed will become more apparent in the following detailed description, in which reference is made to the appended drawing, wherein:

FIG. 1 is a perspective illustration of an elongate plate of a bracket assembly, according to various embodiments.

FIG. 2 is a perspective illustration of a bracket assembly, according to various embodiments.

FIG. 3 is a perspective illustration of a bracket assembly attached to a bracket supporting a new fixture, according to various embodiments.

FIG. 4 is a perspective illustration of a bracket assembly attached to a bracket supporting a new fixture, and a clamp securing the struts to a cylindrical base, according to various embodiments.

FIG. 5 is a perspective illustration of a bracket assembly attached to a U-shaped bracket supporting a new fixture in an alternative orientation, and a clamp securing the struts to a cylindrical base, according to various embodiments.

FIG. 6 is a side-view illustration of a bracket assembly supporting a new fixture inside a housing having a lens, according to various embodiments.

FIG. 7 is a perspective illustration of an alternative bracket assembly supporting a new fixture, according to various embodiments.

Corresponding reference numbers indicate corresponding parts or elements throughout the several views of the drawing.

### DETAILED DESCRIPTION

The present systems and apparatuses and methods are understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

Like parts are marked throughout the following description and drawings with the same reference numerals. The drawings may not be to scale and certain features may be shown exaggerated in scale or in somewhat schematic format in the interest of clarity, conciseness, and to convey information.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to a component can include two or more such components unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

As used herein, the term “facilitate” means to make easier or less difficult and the term “impede” means to interfere with, hinder, or delay the progress. Also, the words “proximal” and “distal” are used to describe items or portions of items that are situated closer to and away from, respectively, a user or operator. Thus, for example, the near end or other portion of an item may be referred to as the proximal end, whereas the generally opposing portion or far end (or free end) may be referred to as the distal end.

Although the various embodiments are described with reference to a generally cylindrical Edison-type screw mount bulb and an LED retrofit kit, the assemblies and methods described herein may be used with any of a variety of lamps, light fixtures, and other mounted objects.

### Bracket Assemblies

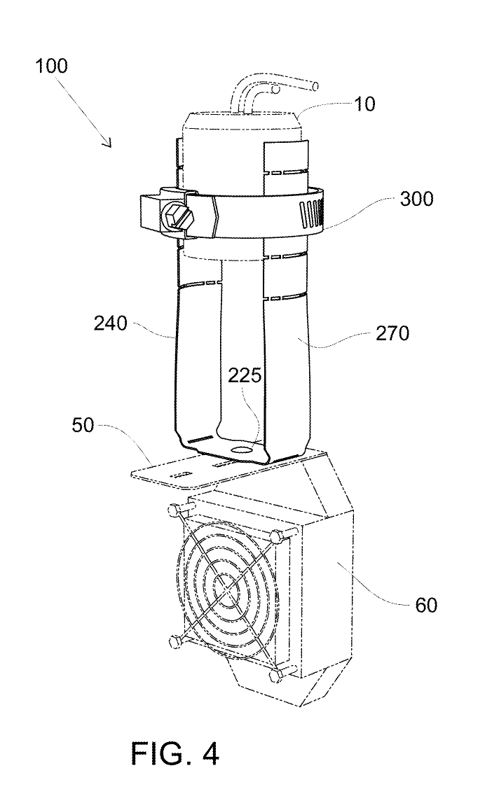

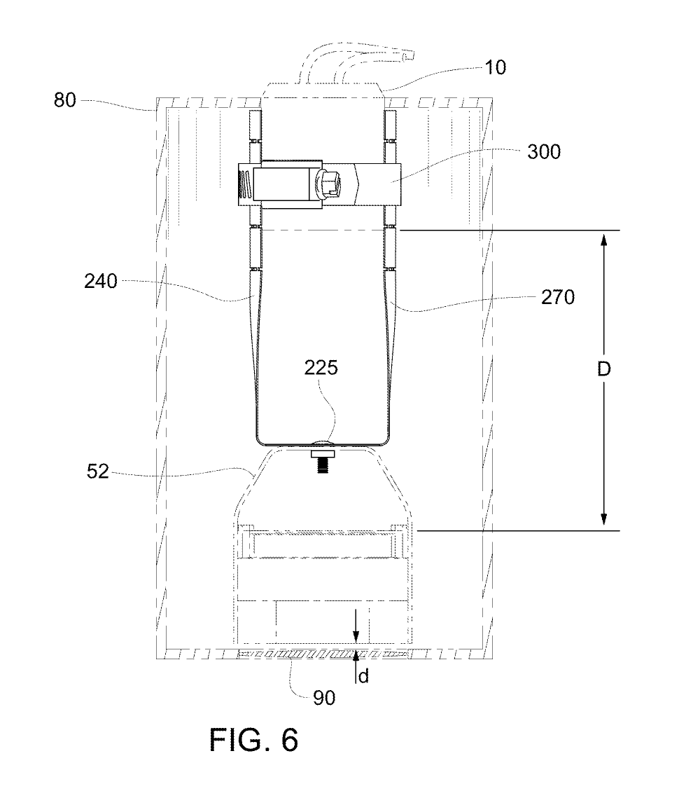

A bracket assembly 100 for securing an object 60 at a selectively adjustable distance apart from a base 10, according to various embodiments, includes an elongate plate 200, a fastener 225, and a clamp 300. The object to be supported may include a bracket 50 supporting a new lighting fixture 60, as illustrated in FIG. 4 and described herein. The base 10 may be a substantially cylindrical base such as an Edison-type screw socket or an E39 Mogul screw mount that was used to support an existing lighting fixture. The existing fixture may include a housing 80 and a lens 90, as shown in FIG. 6.

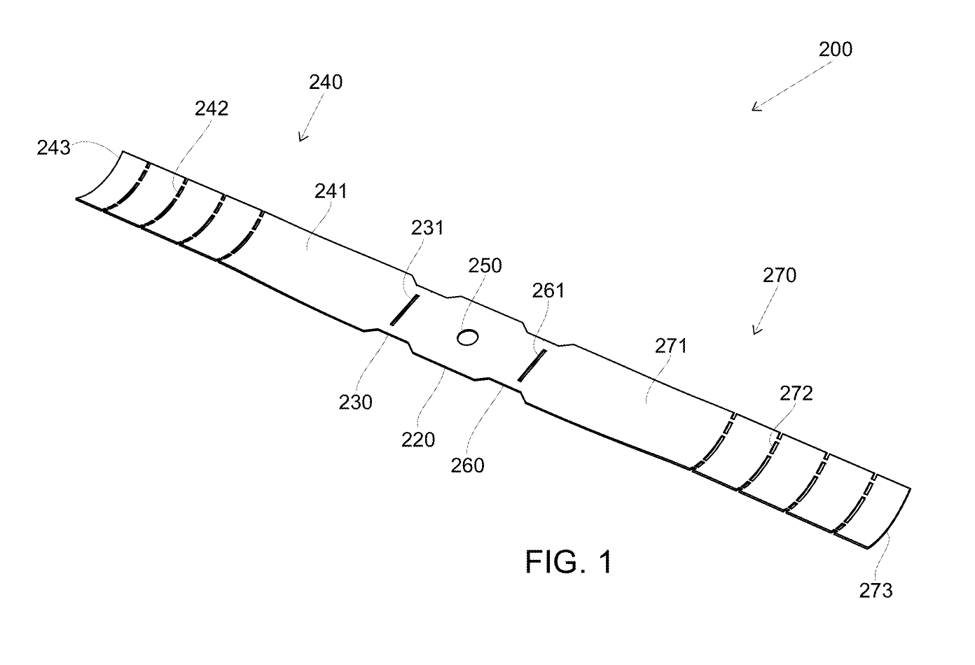

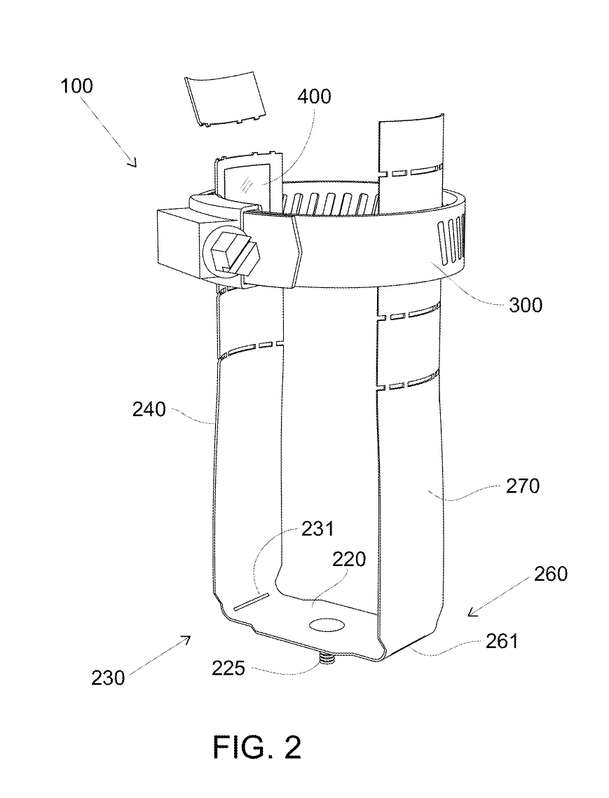

The elongate plate 200, as shown in FIG. 1, may be formed from a single piece of rigid material, such as powder-coated aluminum. The plate 200 may be fabricated by starting with plate metal and stamping or cutting the plate into a particular size and shape. The plate 200 may have a generally uniform thickness. The elongate plate 200 may have a base area 220. The base area 200 may be located near the center of the plate 200. The base area 220 may include a perforation or hole 250 that is sized and shaped to receive a fastener 225 (shown in FIG. 2), such as a machine screw or a bolt with a locking nut. The base area 220, as shown, may be generally rectangular in shape, although it may be formed into any of a variety of shapes to suit a particular purpose.

Referring to FIG. 1, the elongate plate 200 includes a first bendable region 230 which, as shown, may be narrower in width compared to the base area 220. The first bendable region 230 may define a first slot 231 to facilitate bending. Similarly, according to various embodiments, the elongate plate 200 also includes a second bendable region 260 defining a second slot 261 to facilitate bending. As shown, the slot 231, 261 may includes one (or more) holes or transversely oriented elongate slots that are positioned at or near each respective bendable region 230, 260, in order to facilitate bending by reducing the amount of material to be bent. As shown in FIG. 1, the bendable regions 230, 260 are on generally opposing sides of the centrally located base area 220. It should be apparent that the base area need not be limited to shapes that have straight edges. For example, the base area may be circular, oval, or geometrically irregular in shape, and may include one or several bendable regions near or around its perimeter.

The segment of the elongate plate 200 comprising the first strut 240 may have a curved first inner surface 241 and one or more first apertures 242 positioned at one or more intermediate locations between the base area 220 and the first distal end 243. The first strut 240 is contiguous with the base area 220 along the first bendable region 230. Similarly, the segment of the plate 200 comprising the second strut 270 may have a curved second inner surface 271 and one or more second apertures 272 positioned at one or more intermediate locations between the base area 220 and the second distal end 273. The second strut 270 is contiguous with the base area 220 along the second bendable region 260.

The elongate plate 200 when bent at or near the bendable regions 230, 260 to create a bracket, as shown in FIG. 2, in its load-bearing configuration, has a base area 220, a first strut 240, and a second strut 270. The resulting bracket may be generally U-shaped, as shown in FIG. 2, wherein the struts 240, 270 are generally perpendicular to the base area 220. The bracket assembly 100, according to various embodiments, includes the elongate plate 200, a fastener 225, a clamp 300, and an optional adhesive 400. The clamp 300, as shown in FIG. 4, may be sized shaped to at least partially surround and draw together the struts 240, 270 about a cylindrical base 10.

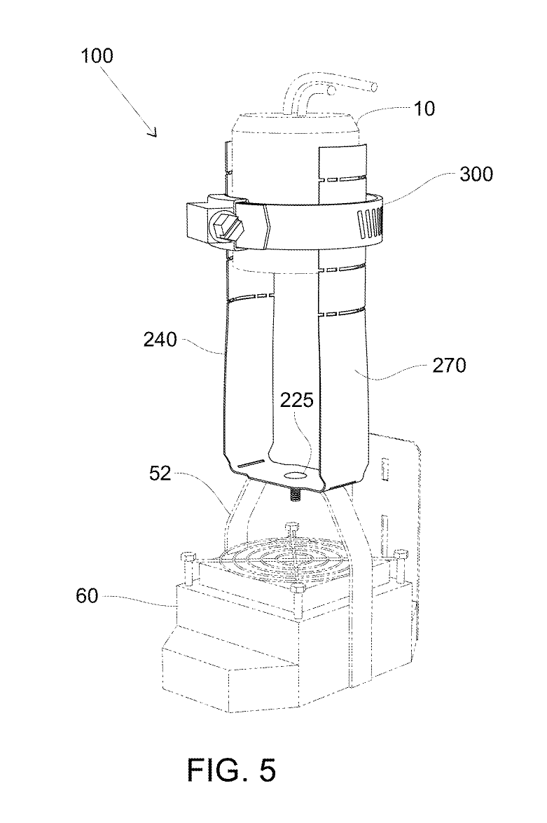

Referring again to FIG. 1, the apertures 242, 272 are sized and shaped to facilitate the breaking, preferably by hand without a tool, of the first strut 240 and second strut 270, respectively, in order to selectively adjust the effective length of the struts 240, 270. In this aspect, the apertures 242, 272 allow an installer in the field to adjust the length of the struts 240, 270 which, in turn, allows the installer to position the object 60 (such as a new fixture 60) at a desired distance from the existing base 10, as illustrated in FIG. 4 and FIG. 5. As shown in FIG. 6, the apertures 242, 272—by facilitating the easy adjustment of the length of the struts 240, 270—also facilitate the positioning of the new fixture 60 inside a housing 80 relative to an existing lens 90. For example, the distance “d” in FIG. 6 represents the preferred distance between the front face of the new fixture 60 and the lens 90. The distance “D” between the rear face of the new fixture 60 and the base 10 may be adjusted by selectively adjusting the length of the struts 240, 270 (by breaking the struts 240, 270 at or near one of the selected apertures 242, 272, respectively). By adjusting the distance “D” the installer can adjust the position the new fixture 60 inside the housing 80 until the fixture 60 is positioned at the preferred distance “d” away from the lens 90. Also, the position of the struts 240, 270 may be adjusted by sliding them along the base 10 until a desired position is achieved, and then using the clamp 300 to secure the struts 240, 270 to the base 10.

As shown in FIG. 1, each set of apertures 242, 272 may include a series of transversely oriented and elongate apertures. Each series may be positioned at one or more intermediate locations along the length of the plate 200 between the base area 220 and the distal ends 243, 273. According to particular embodiments, these intermediate locations may be selected in advance, based on the range of final strut lengths that are likely to be needed by installers in the field. In this aspect, the elongate plate 200 may be manufactured in a number of predetermined and discrete versions, each having a particular set of intermediate locations where the apertures 242, 272 are placed along its length.

As shown in FIG. 4, the bracket assembly may be secured around a substantially cylindrical base 10 which may be an empty, Edison-type screw socket. The struts 240, 270, as shown, may have concavely curved inner surfaces 241, 271, respectively, which may be shaped to correspond to the outer surface of a cylindrical base 10. In this aspect, for a base 10 having a known outer diameter, the concavely curved inner surfaces 241, 271 may be formed to an inner radius that substantially matches the outer surface of the base 10. According to particular embodiments, the elongate plate 200 may be manufactured in a number of predetermined and discrete sizes, in which the inner surfaces 241, 271 are shaped to match the one or more standard sizes of the existing cylindrical bases 10 likely to be found in existing fixtures.

Alternatively, the struts 240, 270 may be generally planar and flat, with no curved inner surface. When securing the struts 240, 270 around a base 10 (having any shape, including cylindrical) the clamp 300 may be designed to exert a force that is sufficient to hold the struts 240, 270 against the outer surface of the base 10. Depending on the materials, this force may be sufficient to bend the struts 240, 270 so that they at least partially conform in shape to the outer surface of the base 10.

The clamp 300, according to particular embodiments, may be a hose clamp, as shown in FIG. 4. Alternatively, the clamp 300 may be any of a variety of fasteners, including for example a hose clamp, hose clip, worm-gear clamp, spring clamp, wire clamp, compression fitting, crimp fitting, or any other fastener capable of securing the struts 240, 270 the exterior of the base 10. The clamp 300 may include a selectively openable band. A hose clamp, for example, includes a steel band having an open end that is inserted into a narrow space between the other end of the band and a captive screw. The open end allows the hose clamp to be opened and placed around the struts 240, 270 and the base 10. After the open end is inserted, the captive screw when turned will tighten the band of the hose clamp.

The bracket assembly 100 may also include an adhesive 400. According to particular embodiments, an adhesive 400 may be placed between one or both of the struts 240, 270 and the outer surface of the base 10, as shown in FIG. 2. The adhesive 400 may be a double-sided pressure-sensitive tape. The clamp 300 may be used to hold the struts 240, 270 against the base 10 while the adhesive 400 cures or otherwise completes the process of bonding with the materials. The adhesive 400 may be selectively releasable during a period, prior to curing, so that the bond is temporary and gives the installer time to position and re-position the struts 240, 270 against the base 10 until a desired final position is achieved. Any of a variety of adhesives may be used to suit the materials of the struts 240, 270 and the base 10. In an alternative embodiment, the adhesive 400 may be a selectively releasable device, such as a hook-and-loop fastener.

Referring to FIG. 4, the base area 220 may be attached using a fastener 225 to a bracket 50 which supports an object such as a new fixture 60. The fastener 225 may be inserted through a hole 250 in the base area 220. The fastener 225 may be a machine screw or a bolt with a locking nut. The bracket 50 may include a single hole, multiple holes, or elongated openings, as shown, so that the fastener 225 may be positioned at any desired location relative to the bracket 50. The bracket 50 may be used to orient the new fixture 60 in a particular direction. For example, in FIG. 4, the bracket 50 holds the new fixture 60 in a generally horizontal orientation. FIG. 5 illustrates a U-shaped bracket 52 which holds the new fixture 60 in a generally vertical orientation.

According to particular embodiments, as shown in FIG. 4, FIG. 5, and FIG. 6, the base 10 may be an empty lamp socket that has been disconnected from any power supply. The new fixture 60 may be connected, separately, to a new power supply. For new LED lighting devices, the new LED fixture may be connected first to a driver (mounted separately) which is then connected to a new power supply.

It will be readily appreciated that the principles and structural elements described herein may be applied to any of a variety of geometries. For example, the generally rectangular base area 220 may be contiguous with two struts 240, 270, as shown and described, or with just one strut; or with three or four struts. A generally triangular base area may support one, two, or three struts. A generally pentagonal base area may support up to five struts, and so forth. Moreover, as described herein, the base area need not be limited to shapes that have straight edges. Any shape may have one or several bendable regions near its perimeter.

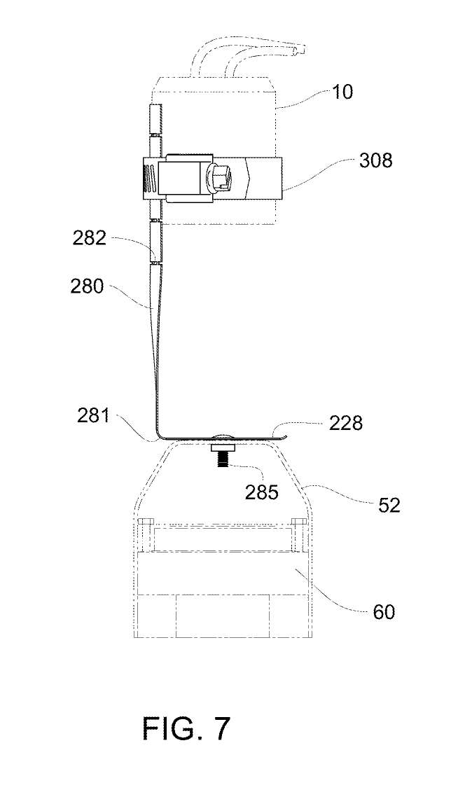

According to one alternative embodiment, the bracket assembly may include one strut, as illustrated in FIG. 7. A bracket assembly that includes a single strut 280 may provide sufficient and stable support for certain applications. As shown, the elongate plate may have a base area 228, a bendable region 281, and a single strut 280. The strut 280 may include one or more apertures 282 positioned at one or more intermediate locations between the base area 228 and the distal end of the strut 280. The base area 228 may be attached using a fastener 285 to a bracket 52 supporting a fixture 60. Once the strut 280 is in position, a clamp 308 may be used to at least partially surround and draw together the strut 280 and the base 10.

### Method of Use

In use, a user or installer may begin by removing an existing fixture from its existing base 10. The installer may disconnect the base 10 from its existing power supply, for example, but cutting the wires.

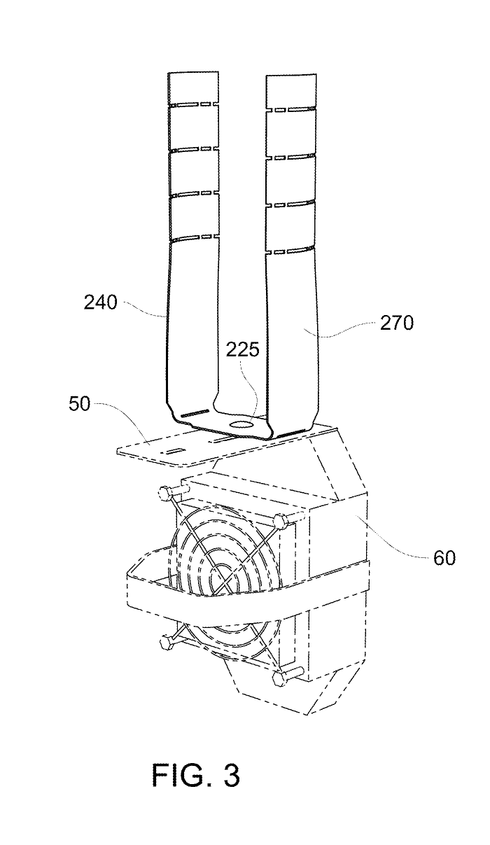

The installer may select an elongate plate 200 that has been pre-sized and shaped to match the geometry of the existing base 10. For example, an installer who is replacing an existing E39 Mogul screw-mounted bulb or lamp may purchase a bracket assembly having an elongate plate 200 with curved inner surfaces 241, 271 that are specifically sized and shaped to fit around an E39 Mogul base. As described herein, the installer may select an elongate plate 200, formed from a single piece of rigid material, wherein the elongate plate 200 includes a base area 220 defining a hole 250 for receiving a fastener 225. The installer may use the fastener 225 to secure the base area 220 to a new fixture 60. Alternatively, as shown in FIG. 3, the installer may use the fastener 225 to secure the base area 220 to a bracket 50 supporting the fixture 60.

Referring to FIG. 1, the elongate plate 200 may be provided to the installer in a generally flat orientation. The installer may form the bracket assembly by bending the elongate plate 200 along the first bendable region 230 to form a first strut 240, and by bending the elongate plate 200 along the second bendable region 260 to form a second strut 270, as shown in FIG. 2. For plates 200 having curved inner surfaces, the installer may execute the bending steps to that the curved inner surface is rotated inwardly, toward the base plate 220. These bending steps may be executed at any time, before or after the base area 220 is attached to the bracket 50, 52 or to the fixture 60.

The installer may select the desired distance between the new fixture 60 and the existing base 10, as illustrated by the dimension “D” in FIG. 6. As described herein, the strut 240, 270 are selectively adjustable in length, using the apertures 242, 272, respectively. As shown in FIG. 2, a strut 240 may be bent and broken, at or near the apertures 242, thereby snapping off the extra length, which may be discarded. As shown in FIG. 6, by adjusting the distance “D” the installer can adjust the position the new fixture 60 inside the housing 80 until the fixture 60 is positioned at the preferred distance “d” away from the lens 90.

Also, the distance “D” may be adjusted by sliding the struts 240, 270 along the outer surface of the base 10 until a desired position is achieved. Optionally, an adhesive may be applied between one or both of the struts 240, 270 and the base 10, as illustrated in FIG. 2. Then, the installer may position the clamp 300 around the struts 240, 270 and the base 10; tightening the clamp 300 when the assembly is in the desired position. The clamp 300 may be selectively reversible, so that it can be loosened when the installer wants to adjust or re-position the assembly.

The installer may then connect the new fixture 60 to a new power supply and/or an a driver, ballast, regulator, circuitry, or other equipment for use with the new fixture 60. In most installations, the existing power supply has been disconnected from the existing base 10. In this aspect of the method, the existing base 10 is used primarily for structural support of the bracket assembly 100 and the new fixture 60. The method takes advantage of the fact that, in many existing fixtures, the existing base 10 is built to support not only the bulb but also the housing and other components of the fixture.

### CONCLUSION

Although several embodiments have been described herein, those of ordinary skill in art, with the benefit of the teachings of this disclosure, will understand and comprehend many other embodiments and modifications for this technology. The invention therefore is not limited to the specific embodiments disclosed or discussed herein, and that may other embodiments and modifications are intended to be included within the scope of the appended claims. Moreover, although specific terms are occasionally used herein, as well as in the claims that follow, such terms are used in a generic and descriptive sense only, and should not be construed as limiting the described invention or the claims that follow.

1. A bracket assembly for securing an object at a selectively adjustable distance from a substantially cylindrical base, comprising:
an elongate plate, formed from a single piece of rigid material and shaped when bent to define, in its load-bearing configuration, a bracket having a base area, a first strut, and a second strut,
wherein said first strut is contiguous with said base area along a first bendable region, and said first strut defines a first aperture positioned at one or more intermediate locations between said base area and a first distal end of said first strut, wherein said first aperture is sized and shaped to facilitate the breaking of said first strut near said first aperture to thereby selectively adjust the length of said first strut,
wherein said second strut is contiguous with said base area along a second bendable region, and said second strut defines a second aperture positioned at one or more intermediate locations between said base area and a second distal end of said second strut, wherein said second aperture is sized and shaped to facilitate the breaking of said second strut near said second aperture to thereby selectively adjust the length of said second strut,
wherein each of said first and second struts has a concavely curved inner surface shaped to substantially correspond to an outer surface of a substantially cylindrical base, and
wherein said base area defines a hole for receiving a fastener;
a fastener for securing said base area to an object; and
a clamp sized and shaped to at least partially surround and draw together said first and second struts about said substantially cylindrical base.

2. The bracket assembly of claim 1, wherein said first bendable region defines a first slot to facilitate bending.

3. The bracket assembly of claim 2, wherein said first slot comprises one or more transversely oriented elongate first slots.

4. The bracket assembly of claim 1, wherein said first aperture comprises a series of one or more transversely oriented elongate first apertures.

5. The bracket assembly of claim 1, wherein each of said first and second struts, when bent to define said bracket, is oriented substantially perpendicular to said base area.

6. The bracket assembly of claim 1, wherein said clamp comprises a fastener selected from the group consisting of hose clamp, hose clip, worm-gear clamp, spring clamp, wire clamp, compression fitting, and crimp fitting.

7. The bracket assembly of claim 1, wherein said bracket assembly further comprises an adhesive positioned between one or more of said first and second struts and said cylindrical base.

8. The bracket assembly of claim 1, wherein said object comprises a bracket supporting a new fixture.

9. The bracket assembly of claim 1, wherein said object comprises a new lighting fixture connected to a new power supply and said substantially cylindrical base comprises an empty lamp socket disconnected from any power supply.

10. The bracket assembly of claim 1, wherein said object comprises a new lighting fixture and said substantially cylindrical base is positioned within a housing having a lens, and
wherein at least one of said first and second struts is selectively adjusted in length to facilitate the positioning of said new lighting fixture within said housing at a preferred distance apart from said lens.

11. A method for securing a new fixture at a selectively adjustable distance from the base of an existing fixture, comprising the steps of:
removing an existing fixture from its substantially cylindrical base;
selecting an elongate plate, formed from a single piece of rigid material, wherein said elongate plate includes a base area defining a hole for receiving a fastener;
securing said base area to a new fixture using said fastener;
bending said elongate plate along a first bendable region to form a first strut, said first strut defining a first aperture positioned at one or more intermediate locations between said base area and a first distal end of said first strut, wherein said first aperture is sized and shaped to facilitate breakage of said first strut near said first aperture;
bending said elongate plate along a second bendable region to form a second strut, said second strut defining a second aperture positioned at one or more intermediate locations between said base area and a second distal end of said second strut, wherein said second aperture is sized and shaped to facilitate breakage of said second strut near said second aperture;
selecting a desired distance between said new fixture and said substantially cylindrical base, and selectively adjusting the length of said first and second struts by breaking said first and second struts near one of said intermediate locations in order to achieve said desired distance; and
positioning and securing a clamp at least partially around said first strut, said second strut, and said substantially cylindrical base.

12. The method of claim 11, wherein said step of securing said base area comprises securing said base area to a bracket supporting said new fixture.

13. The method of claim 11, further comprising the steps of:
disconnecting said substantially cylindrical base from its existing power supply; and
connecting said new fixture to a new power supply.

14. The method of claim 11, wherein each of said first and second struts has a concavely curved inner surface shaped to substantially correspond to said substantially cylindrical base of said existing fixture,
wherein said steps of bending further comprise bending said elongate plate such that each of said inner surfaces is rotated toward said base plate.

15. The method of claim 11, wherein said first bendable region defines one or more transversely oriented first slots that are sized and shaped to facilitate said step of bending said elongate plate to form said first strut.

16. The method of claim 11, wherein said first aperture comprises one or more transversely oriented first elongate apertures that are sized and shaped to facilitate said step of selectively adjusting the length of said first strut by breaking.

17. The method of claim 11, wherein said step of positioning and securing said clamp further comprises the preparatory step of first positioning an adhesive between one or more of said struts and said substantially cylindrical base.

18. The method of claim 11, wherein said existing fixture comprises said substantially cylindrical base positioned within a housing having a lens,
wherein said step of selecting a desired distance between said new fixture and said base further comprises positioning said new fixture within said housing at a preferred distance apart from said lens.
